(19) United States
(12) Patent Application Publication
(10) Pub. No.: US 2026/0324543 A1
(43) Pub. Date: Oct. 22, 2026

(54) AUTOMATIC LOCKOUT CONTROL FOR AN AGRICULTURAL MACHINE

(71) Applicant: Deere & Company, Moline, IL (US)

(72) Inventors: Shreyas P. Modak, Bettendorf, IA (US); Alex A. Brimeyer, Bettendorf, IA (US)

(21) Appl. No.: 19/184,238

(22) Filed: Apr. 21, 2025

(51) Int. Cl. A01D 34/00; A01D 34/04; A01D 34/24

(52) U.S. Cl. CPC A01D 34/008; A01D 34/04; A01D 34/246

(57) ABSTRACT

A header system of an agricultural machine includes a header assembly having a frame, a cutterbar assembly for cutting the crop during the harvesting operation, and a plurality of support arms coupled between the frame and the cutterbar assembly. The header system also includes a control system for controlling the header assembly between a raised position and a lowered position and the cutterbar assembly between an unlocked configuration and a locked configuration. When the header assembly is in the lowered position and the cutterbar assembly is in the unlocked configuration, the control system receives a signal and moves the header assembly from the lowered position to the raised position and controls the cutterbar assembly from the unlocked configuration to the locked configuration.

### FIELD OF THE DISCLOSURE

The present disclosure relates to an agricultural machine and more particularly to an automatic exit cut lockout system for a header assembly of an agricultural machine.

### BACKGROUND

here are a variety of different types of agricultural machines. Some agricultural machines include combine harvesters, sugarcane harvesters, cotton harvesters, self-propelled forage harvesters, and windrowers. Some agricultural machines can include different header assemblies coupled to the agricultural machine for harvesting different types of crops. Some header assemblies include a cutterbar assembly capable of cutting crop over uneven terrain during a harvesting operation.

### SUMMARY

In one implementation of the present disclosure, a header system of an agricultural machine for performing a harvesting operation to harvest a crop in a field includes a header assembly having a frame, a cutterbar assembly configured to cut the crop during the harvesting operation, and a plurality of support arms coupled between the frame and the cutterbar assembly, wherein the cutterbar assembly is controlled between an unlocked configuration and a locked configuration; and a control system configured to control the header assembly between a raised position and a lowered position and the cutterbar assembly between the unlocked configuration and the locked configuration; wherein, when the header assembly is in the lowered position and the cutterbar assembly is in the unlocked configuration, in response to a signal the control system is configured to move the header assembly from the lowered position to the raised position and control the cutterbar assembly from the unlocked configuration to the locked configuration.

In one example of this implementation, the control system includes an operator control, the control system configured to receive the signal from the operator control to move the header assembly from the lowered position to the raised position and control the cutterbar assembly from the unlocked configuration to the locked configuration. In another example, the control system includes a controller configured to detect a location of the agricultural machine in the field, the control system configured to receive the signal from the controller to automatically move the header assembly from the lowered position to the raised position and control the cutterbar assembly from the unlocked configuration to the locked configuration based on the location of the agricultural machine in the field.

In a third example, when the signal is from the controller and identifies that the location of the agricultural machine is in or approaching a headland portion of the field, the control system is configured to automatically send a second signal to move the header assembly from the lowered position to the raised position and a third signal to control the cutterbar assembly from the unlocked configuration to the locked configuration. In a fourth example, the control system includes a second controller configured to control the agricultural machine, the second controller configured to receive the signal from the controller; determine, based on the signal and a field map, if the location of the agricultural machine corresponds to a first area or a second area in the field; if the location is in the first area, maintain the header assembly in the lowered position and the cutterbar assembly in the unlocked configuration; and if the location is in the second area, automatically move the header assembly from the lowered position to the raised position and control the cutterbar assembly from the unlocked configuration to the locked configuration.

In a fifth example, the control system includes at least one sensor coupled to the header assembly, the at least one sensor configured to detect a height of the header assembly relative to a ground surface in the field. In a sixth example, the header assembly is controllable in a first mode and a second mode; wherein, in the first mode, the header assembly is disposed in the lowered position and the cutterbar assembly is in the unlocked position; wherein, in the second mode, the header assembly is disposed in the raised position and the cutterbar assembly is in the locked position. In a seventh example, the control system includes an operator control configured to be selectively enabled to hold the cutterbar assembly in the locked configuration; wherein, when the operator control is selectively enabled, the control system is configured to maintain the cutterbar assembly in the locked configuration independent of the signal. In a further example, a hydraulic system is disposed in communication with the control system, wherein the control system is configured to enable the hydraulic system for moving the header assembly between the lowered position and the raised position and moving the cutterbar assembly between the locked configuration and the unlocked configuration.

In another implementation of the present disclosure, a header system of an agricultural machine performing a harvesting operation to harvest crop in a field includes a header assembly including a frame, a cutterbar assembly configured to cut the crop during the harvesting operation, and a plurality of support arms coupled between the frame and the cutterbar assembly, wherein the cutterbar assembly is controlled between an unlocked configuration and a locked configuration; an operator interface including a plurality of operator controls, the plurality of operator controls including a first operator control and a second operator control, wherein, when the first operator control is enabled, the first operator control is configured to automatically control the cutterbar assembly to the locked configuration, and when the second operator control is enabled, the second operator control is configured to enable an exit cut auto lock logic; and a control system including at least one controller, the control system configured to control the header assembly between a raised position and a lowered position and the cutterbar assembly between the unlocked configuration and the locked configuration; wherein, when the header assembly is in the lowered position and the cutterbar assembly is harvesting crop during the harvesting operation, in response to a signal from one of the plurality of operator controls or the at least one controller, the control system is configured to move the header assembly from the lowered position to the raised position and control the cutterbar assembly from the unlocked configuration to the locked configuration.

In one example of this implementation, the control system includes at least one sensor, the at least one sensor configured to detect a height of the header assembly relative to a ground surface in the field. In a second example, when the first operator control is enabled, the cutterbar assembly is in the locked configuration independent of whether the header assembly is in the raised position or lowered position. In a third example, only the first operator control or the second operator control is configured to be selectively enabled.

In a fourth example, when the second operator control is enabled and the cutterbar assembly is in the unlocked configuration, the control system is configured to receive the signal from the at least one controller to automatically move the header assembly from the lowered position to the raised position and control the cutterbar assembly from the unlocked configuration to the locked configuration. In a fifth example, when the second operator control is enabled and the cutterbar assembly is in the unlocked configuration, the control system is configured to receive the signal from a third operator control of the plurality of operator controls to move the header assembly from the lowered position to the raised position and control the cutterbar assembly from the unlocked configuration to the locked configuration.

In a sixth example, the at least one controller includes a first controller configured to control the agricultural machine, a second controller configured to move the header assembly between a raised position and a lowered position, a third controller configured to control the cutterbar assembly between the unlocked configuration and locked configuration, and a fourth controller configured to identify a location of the agricultural machine in the field. In a seventh example, the control system is configured to receive the signal from the fourth controller and automatically move the header assembly from the lowered position to the raised position and control the cutterbar assembly from the unlocked configuration to the locked configuration based on the location of the agricultural machine in the field.

In another example, when the signal is from the fourth controller and identifies that the location of the agricultural machine is in or approaching a headland portion of the field, the control system is configured to automatically send a second signal to the second controller to move the header assembly from the lowered position to the raised position and a third signal to the third controller to control the cutterbar assembly from the unlocked configuration to the locked configuration based on the location of the agricultural machine in the field.

In a further implementation of the present disclosure, a method of controlling a header system of an agricultural machine during a harvesting operation in a field includes providing a header assembly including a cutterbar assembly and a plurality of support arms operably coupled to the cutterbar assembly, a hydraulic system, and a control system including an operator control, a controller, and a sensor; harvesting, via the header assembly, a crop in the field during the harvesting operation with the header assembly disposed in a lowered position and the cutterbar assembly disposed in an unlocked configuration; receiving, via the control system, a first signal from the operator control to enable an exit cut auto lock algorithm; during the harvesting operation, receiving a second signal via the control system from the operator control or controller to move the header assembly from the lowered position to a raised position; operably moving, via the control system, the header assembly from the lowered position to the raised position; and controllably moving, via the control system, the cutterbar assembly from the unlocked configuration to the locked configuration.

In one example of this implementation, when the exit cut auto lock algorithm is enabled, the header assembly is in the raised position, and the cutterbar assembly is in the locked configuration, the method further includes receiving a third signal, via the controller, from the operator control or the controller to lower the header assembly from the raised position to the lowered position; operably moving the header assembly from the raised position to the lowered position; detecting, via the sensor, the header assembly is in the lowered position; and controllably moving, via the control system, the cutterbar assembly from the locked configuration to the unlocked configuration.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings.

FIG. 1 is a fragmentary top view illustrating portions of an example agricultural harvester with an example agricultural harvester header.

FIG. 2 is a perspective view of an agricultural harvesting header.

FIG. 3 is a block diagram of a control system of the agricultural harvester.

FIG. 4 is a flow diagram of a method for controlling an automatic lockout for an agricultural harvester.

FIG. 5 is a user interface having a user input screen.

FIG. 6 is a flow diagram of a method for controlling a hydraulic system including control of a high pressure rail for an agricultural harvester.

### DETAILED DESCRIPTION

The implementations of the present disclosure described below are not intended to be exhaustive or to limit the disclosure to the precise forms disclosed in the following detailed description. Rather, the implementations are chosen and described so that others skilled in the art may appreciate and understand the principles and practices of the present disclosure.

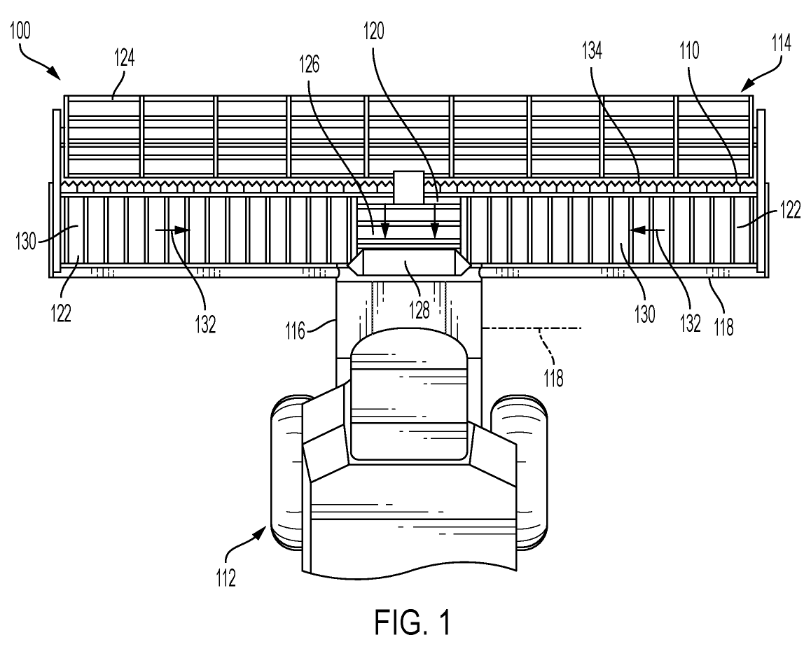

In FIG. 1 of the present disclosure, one implementation of an agricultural machine 100 is shown. The agricultural machine may include, for example, an agricultural harvester such as a combine harvester. In one implementation, the agricultural machine 100 may include a float arm support system 110. In some implementations, the agricultural machine 100 includes a main drive 112, such as a tractor, and a removable header or header assembly 114. The main drive 112 supports the header assembly 114 and moves or carries the header assembly 114 across a ground surface of a field to harvest a crop during a harvesting operation. Main drive 112 includes a feeder or feeder house 116 that is pivotable about a pivot axis 118 at one end and removably coupled to the header assembly 114 at the other end thereof. The feeder house 116 receives and conveys crop gathered by the header assembly 114 to internal mechanisms within the main drive 112. In some implementations, the internal mechanisms of the main drive 112 are configured to separate and clean selected portions of the crop, such as grain, from the accompanying biomass material, such as husk, chaff and the like. In one implementation, the main drive 112 includes straw walkers or a rotary threshing mechanism with rearwardly located chafers or sieves for separating out grain. In one implementation, the cleaned crop or grain is conveyed to a holding tank (e.g., a grain tank) for collection. In some implementations, the non-grain portions or biomass are discharged at a rear of the agricultural machine 100.

In some implementations, the agricultural machine 100 may be an agricultural harvester or a combine harvester having a frame coupled to the header assembly 114. In one or more implementations, the agricultural machine 100 is a self-contained machine where the main drive 112 and the header assembly 114 are part of a unitary machine in which the header assembly 114 is fixedly coupled to the main drive 112.

In one implementation, the main drive 112 includes a cab where an operator of the agricultural machine 100 is located to operate or control the agricultural machine 100 during the harvesting operation. In other implementations, an autonomous machine including a propulsion system having a power mover, such as an engine, is coupled to the header assembly 114. An entirely self-contained autonomous agricultural harvester is also contemplated in this disclosure. In addition, the agricultural machine 100 may be remotely operated and include a remotely located operator.

Referring to FIG. 1, the header assembly 114 includes a main frame 118, a center feed section 120, platform wings 122, a gathering reel 124 and a float arm support system 110. The main frame 118 supports the center section 120 and platform wings 122. The main frame 118 is also coupled to the feeder house 116. The center feed section 120 extends from the main frame 118 and includes a central draper 126 and a feed drum 128. The central draper 216 conveys the crop received from the platform wings 122 rearwardly towards the feed drum 128 and feeder house 116.

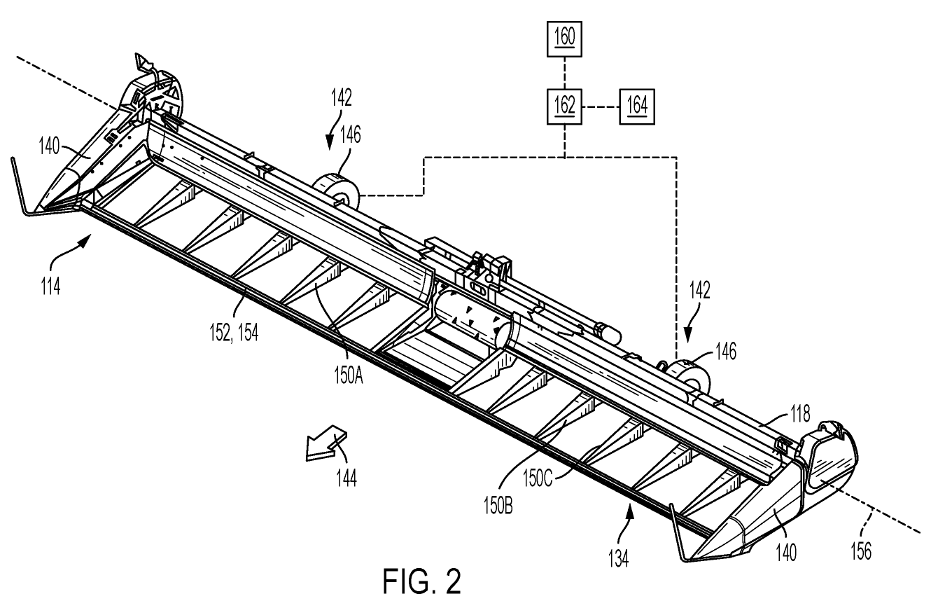

The platform wings 122 extend in a transverse direction relative to a direction of travel 144 (see FIG. 2) on either side of center feed section 120. In some implementations, each platform wing 122 may include a draper similar to the central draper 126. For example, each of the platform wings 122 may include a framework that movably supports a draper 130. In FIG. 1, the drapers 130 may include carpets, platforms or belts which are transversely driven as indicated by arrows 132 so as to carry the severed plants or crops to the central draper 126.

The gathering reel or reels 124 is rotatably supported across the front of the header assembly 114. The gathering reel or reels 124 is rotatably driven to direct the crop towards a cutterbar assembly 134, which is also referred to herein as the cutterbar assembly 134. In some implementations, the gathering reel or reels 124 is segmented, wherein the different segments may pivot relative to one another when traversing changes in the underlying terrain.

Referring to FIG. 2 of the present disclosure, the header assembly 114 includes a pair of side housings 140 along each side of the frame 118. In some implementations, the side housings 140 are referred to as cones or snoots. The header assembly 114 is moveable along the ground surface (i.e., underlying terrain) that supports the agricultural machine 100. The header assembly 114 also includes one or more gauge assemblies (e.g., gauge wheel assemblies 142) coupled to a rear side of the frame 118 relative to the forward direction of travel 144 of the agricultural machine 100. In some implementations, the gauge wheel assemblies 142 are pivotably coupled to the frame 118 to be selectively engageable with the ground surface. Each gauge wheel assembly 142 includes one or more wheels 146 (i.e., gauge wheels 142) coupled to a support bracket (not shown), which is pivotably coupled to the frame 118. In other implementations, the header assembly 114 can include one gauge wheel assembly 142 or more than two gauge wheel assemblies 142. Each of the gauge wheel assemblies 142 may include an actuator configured to adjust a position of the respective gauge wheel 146 with respect to the main drive 112 between a fully extended position and a fully retracted position.

As shown in FIG. 2, the header assembly 114 also includes a plurality of support arms 150 that are pivotably coupled to the frame 118 and operably support the cutterbar assembly 134. As also shown in FIG. 2, the cutterbar assembly includes a reciprocating knife 152 having cutting teeth 154 that are configured to cut crop as it is collected by the gathering reel 124 during the harvesting operation. At least one of the side housings 140 includes a drive mechanism (not shown) operable to reciprocate the knife 152 along a longitudinal axis 156 of the frame 118. The plurality of support arms 150 provide support for the cutterbar assembly 134 as well as for the drapers 130.

As the header assembly 114 moves along the ground surface, independent movement of the plurality of support arms 150A, 150B, and 150C allows the cutterbar assembly 134 to bend or flex along the longitudinal axis 156 of the frame 118 while the knife 152 reciprocates along the longitudinal axis 156. While three of the plurality of support arms 150A, 150B, and 150C are shown and described as having independent movement, in other implementations the cutterbar assembly 134 may be a flexible cutterbar assembly formed by one or more independently movable support arms. In one or more implementations, each of the plurality of supports arms 150 may be enabled to move freely in a generally vertical direction relative to the ground surface to enable the cutterbar assembly 134 to follow the contour of the ground surface in a flexible or unlocked configuration. In some implementations, the plurality of support arms 150 may be locked to preclude movement so as to reconfigure the cutterbar assembly 134 in a rigid or locked configuration. In several implementations, one or more of the plurality of support arms 150 may move freely (e.g., in a flexible or unlocked configuration, whereas in other implementations none of the plurality of support arms are enabled to move freely (e.g., in a rigid or locked configuration). In some implementations, each of the plurality of support arms includes a lock or locking system which, when enabled or locked, prevents movement of the respective support arm 150 and thus prevents flexing of the cutterbar assembly 134.

In one implementation, portions of the knife 152 are allowed to flex as each support arm 150 moves over an uneven ground surface. This flexible movement of the support arm 150 allows the cutting teeth 154 to remain in relatively close proximity to the uneven ground surface without digging into or engaging the ground surface. As such, plant matter (e.g., crops such as corn stalks, bean stalks, etc.) extending above the surface can be cut by the cutting teeth 154 relatively close to the ground surface while the header assembly 114 is in a lowered, cutting position.

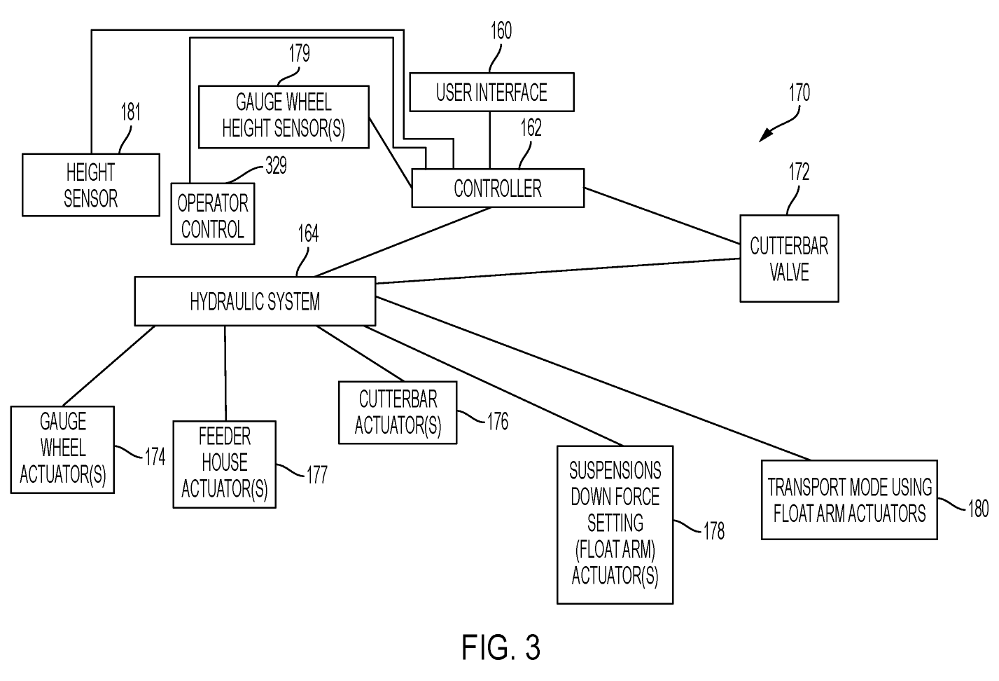

In some implementations, it is desirable to lock the cutterbar assembly 134 or knife 152 from bending or flexing when positioning the header assembly 114 in a raised position. To do this, a control system 170 as shown in FIG. 3 may be provided for controlling at least a portion of the agricultural machine 100. The control system 170 includes a controller 162 that is disposed in communication with an operator or user interface (UI) 160. The control system 170 may include a plurality of sensors, actuators, and controls for controlling the agricultural machine 100.

Referring to FIG. 3, the operator of the agricultural machine 100 may select a desired height to position the header assembly 114 above the ground surface via the operator or user interface (UI) 160. In one implementation, the controller 162, in response to a height selection input by the operator via the operator or user interface 160, controllably adjusts the height of the header assembly 114 above the ground surface.

In some implementations, the control system 170 may include a plurality of controllers 162. For example, in one implementation, the controller 162 may include a first or machine controller that receives inputs from the operator or user interface 160 and sends commands to other controllers or systems on the agricultural machine 100. In another implementation, the controller 162 may include a second or feeder house controller. The feeder house controller may control movement of the header assembly 114 and feeder house 116 between a raised position and a lowered position. In a further implementation, the controller 162 may include a third or header controller. The header controller controls header height sensing (described below) and locking or unlocking the support arms 150 of the cutterbar assembly 134. The header controller may be disposed in communication with a height sensor 181 as described below.

In yet another implementation, the controller 162 may include a fourth or global positioning sensor (GPS) controller. The GPS controller may be configured to detect a location of the agricultural machine 100 as it traverses a field. In some implementations, the GPS controller is configured to identify, using a map of the field, the location of the agricultural machine 100 as the agricultural machines approaches a headland portion of the field. The headland or headland portion is described in further detail below. In another implementation, the GPS controller is configured to identify what portions in a map of the field have been harvested by the agricultural machine as well as what portions in the map of the field have not been harvested. Further, in some implementations, the map identifies portions of the field that include crop and portions of the field that do not include crop, whether the result of harvesting or otherwise. In this way, the GPS controller may send a signal to the user interface 160 or another controller 162 indicative of the location in the field where the agricultural machine 100 is located, what portions of the field that do not include crop, e.g., portions that have been harvested, and what portions of the field include crop, e.g., portions that have not been harvested. In yet further implementations, the GPS controller may receive a signal from a user interface 160 or another controller indicating areas in the field the agricultural harvester 100 is not to harvest crop (e.g., there may not be crop in a given area in the field, the area in the field is too wet to harvest crop, another agricultural machine is to harvest crop in a given area, etc.). In yet another implementation, the controller 162 (e.g., GPS controller or other controller) may identify an area in the field the agricultural machine should not harvest and thus the header assembly 114 and feeder house 116 are moved to the raised position in the event the agricultural machine 100 traverses the given area in the field.

In some implementations of the control system 170, a gauge wheel height sensor 179 and a height sensor 181 (e.g., header height sensor) are provided. In other implementations, additional or fewer sensors may be provided. In FIG. 3, the gauge wheel height sensor 179 is configured to detect the position of the gauge wheel assembly relative to the frame 118 of the header assembly 114. The gauge wheel height sensor 179 is further configured to communicate a signal indicative of the position of the gauge wheel assembly relative to the frame 118 of the header assembly to the controller 162. The height sensor 181 is configured to detect a relative height of the header assembly 114 relative to an underlying ground. The height sensor 181 is also configured to communicate a signal to the controller 162 indicative of the relative height (or actual height) of the header assembly 114 relative to ground. The controller 162, upon receiving an operator selected height in combination with the signal of the actual height received from the height sensor, transmits a control signal to a hydraulic system 164 to raise the header assembly 114 from the actual height to the operator selected height. In the case of an autonomous machine, the operator or user interface 160 may be remotely located from the autonomous machine such that the operator selected height (e.g., desired height) of the header assembly 114 is selected by a remote operator. In another implementation of the autonomous machine, the features provided by the operator or user interface 160 may be selected based on a field map identifying field conditions and crop conditions. The field map may be stored in a memory unit located on the agricultural machine, in the controller 160, or remotely from the agricultural machine such as in a cloud system.

In several implementations, the controller 162 includes a computer, computer system, or other programmable devices. In some implementations, the controller 162 may include one or more processors (e.g. microprocessors), and an associated memory, which can be internal or external to the processor. The memory may include, in different implementations, random access memory (RAM) devices including the memory storage of the controller, as well as any other types of memory, e.g., cache memories, non-volatile or backup memories, programmable memories, or flash memories, and read-only memories. In addition, the memory, in different implementations, includes a memory storage physically located elsewhere from the processing devices, and can include any cache memory in a processing device, as well as any storage capacity used as a virtual memory, e.g., as stored on a mass storage device or another computer coupled to controller 162. The mass storage device can include a cache or other dataspace which can include databases. Memory storage, in other implementations, may be located in a cloud system, also known as the "cloud", where the memory is located at a location remote from the machine to provide the stored information wirelessly to the controller 162 through an antenna operatively connected to a transceiver, which is operatively connected to the controller 162. When referring to the controller 162, the processor, and the memory, other types of controllers, processors, and memory are contemplated. Use of the cloud for storing data, in one implementation, leads to storage economies of scale at a centrally located operation’s center, where data from a large number of agricultural systems may be stored. In other implementations, data from other types of work machines is stored.

Referring to FIG. 3, the control system 170 of the agricultural machine 100 includes a cutterbar valve 172 operatively connected to the controller 162 as well as to the hydraulic system 164. The hydraulic system 164 is disposed in communication with the controller 162. In one or more implementations, the cutterbar valve 172 includes, but is not limited to, a valve, a solenoid, , a motorized valve or any other type of electro-hydraulic control.

The controller 162, in response to signals received from the operator or user interface 160, transmits one or more signals under certain conditions to the cutterbar valve 172. The cutterbar valve 172 is movable between a closed position and an open position. In one or more implementations, the hydraulic system 164 includes one or more gauge wheel actuators 174 for controlling a movement of the gauge wheels 146, one or more cutterbar actuators 176 for controlling movement of the plurality of support arms 150, one or more feeder house actuators 177 for controlling movement of the feeder house 116, and one or more actuators 178 for the float arm support system 110.

In one implementation, the height sensor 181, also referred to as a header height sensor, is operatively connected to the header assembly 114 and is configured to detect a height of the header assembly 114 relative to ground. The height sensor 181 is disposed in communication with the controller 162 in one implementation. In another implementation, the height sensor 181 is disposed in communication with the hydraulic system 164.

In the illustrated implementation of FIG. 3, the hydraulic system 164 includes one or more transport mode actuators 180 that are configured to move the header assembly 114 to a transport position. In one implementation, the transport mode actuators 180 include the float arm actuators 178. In one implementation, the float arm actuators 178 are adjustably controlled to provide a selected amount of damping to the float arm support system (which includes the support arms 150).

In one implementation, the header assembly 114 of an agricultural machine 100 may be configured or positioned in a plurality of positions or configurations. For example, in some implementations, the header assembly 114 may be positioned in an operating position or configuration for harvesting crop. In another implementation, the header assembly 114 may be positioned in a transport position or configuration where the header assembly 114 is not performing a harvesting operation. Instead, in some implementations, the header assembly 114 is being transported to another location (e.g., another field, another crop row in a field, etc.). In a further implementation, the header assembly 114 may be positioned in a shipping position or configuration such that, for example, the header assembly 114 is loaded on a transport trailer for being shipped to a new location.

As described above, the height sensor 181 detects a position or height of the header assembly 114 relative to ground. With the height sensor 181 being in communication with the controller 162, the height sensor 181 transmits a signal indicative of the height of the header assembly 114 to the controller 162. The detected height by the height sensor 181 provides a signal indicative of the actual height of the header assembly 114 with respect to the ground surface.

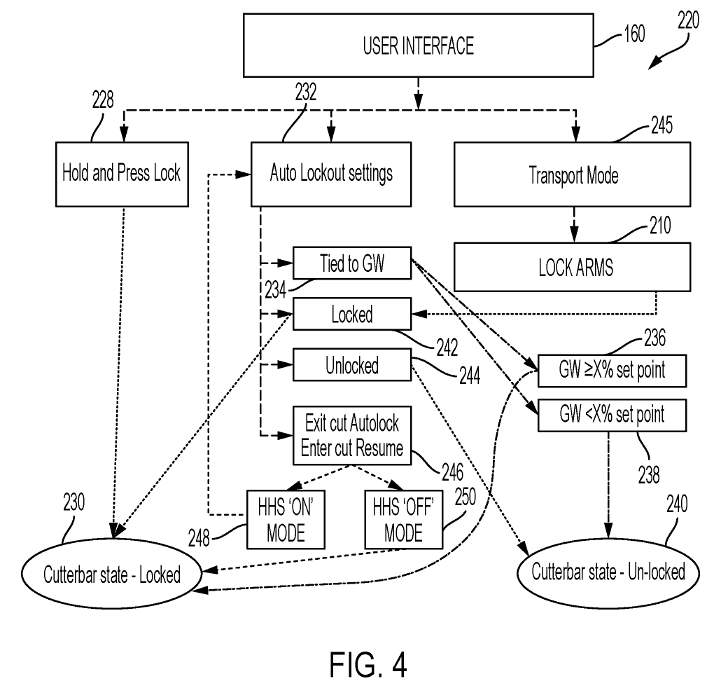

In FIG. 4 of the present disclosure, a flow diagram of a method 220 of controlling an automatic lockout of the header assembly 114 of the agricultural machine 100 is shown. The method 220 is shown including a plurality of blocks that may be executed by the controller 162. For example, the controller 162 may include a processor capable of executing the plurality of blocks. Moreover, the plurality of blocks of method 220 may be executed in any order. Thus, the order of the plurality of blocks in FIG. 4 is only shown as a single implementation of the method 220, and other implementations of the method 220 may include fewer blocks, more blocks, and/or the plurality of blocks arranged in an order different from that of FIG. 4. In other words, the method 220 of FIG. 4 is only one implementation of a plurality of implementations contemplated by the present disclosure and is not intended to limit the scope of the disclosure.

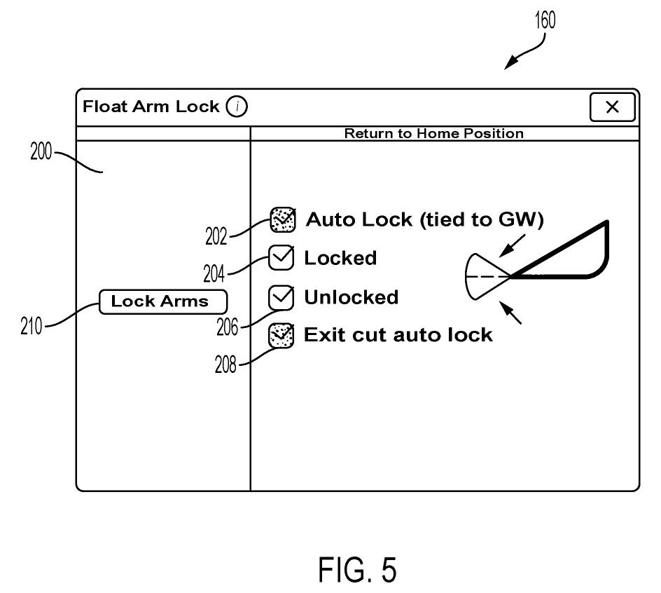

The method 220 of FIG. 4 may be executed by the controller 162 by receiving one or more inputs via the operator or user interface 160 from an operator of the agricultural machine 100. In the implementation of FIG. 5, for example, the operator or user interface 160 includes an operator or user input screen 200 (i.e., input screen). In one or more implementations, the input screen 200 may include a touchscreen with one or more selectable buttons and an operator voice activated input device. The input screen 200 may be located in a cab of the agricultural machine 100 or on a remote device such as a mobile device or laptop. As shown in FIG. 5, the input screen 200 includes one or more operator selectable buttons or controls, i.e., operator selectable controls, each of which is selectable by the operator. In different implementations, the operator selectable controls may include capacitive touch buttons, photoelectric sensors, temperature buttons, switches, a keypad, or pressure sensitive buttons including manual keys having mechanical switches. The input screen 200 illustrated in FIG. 5 is one implementation of an operator or user interface 160. For purposes of this disclosure, other operator interfaces are contemplated. Each of the operator selectable controls may be referred herein as operator controls.

The user input screen 200 provides one or more operator controls that, when selected by the operator, transmits a corresponding input signal to the controller 162 for locking or unlocking the float arm support system 110. Referring to the implementation of FIG. 5, for example, the one or more operator controls on the input screen 200 includes an auto lock user control 202, a locked or lock control 204, an unlocked or unlock control 206, an exit cut auto lock control 208, and a lock arms control 210. Each of these operator controls and their respective function is described below.

The auto lock (AL) control 202 may be selected by the operator to transmit a signal to the controller 162 to control the hydraulic system 164 to an automatic lock condition or state in which the float arm actuators 178 are automatically locked upon retraction of the gauge wheel assemblies 142. In one or more implementations, automatic locking of the float arm actuators 178 may be advantageous when harvesting a taller crop (e.g., rice, wheat or corn), the harvesting conditions are wet (e.g., the ground surface is wet or muddy) or placing the header assembly 114 on a trailer for transport. The lock control 204 may be selected by the operator to lock the cutterbar actuators 176 in a configuration where the cutterbar assembly 134 is locked until one of the other operator controls is selected to unlock the cutterbar assembly 134. In this configuration with the lock control 204 enabled, the header controller 162 is unable to unlock the support arms 150 and thus the cutterbar assembly 134 even if the header assembly 114 is lowered. The unlock control 206 may be selected by the operator to control the float arm actuators 178 in an unlocked configuration. As described previously, the float arm actuators 178 operably control the support arms 150 and thus the cutterbar assembly 134. The float arm actuators 178 may remain in the unlocked configuration until the operator selectively enables another operator control. When the auto unlock control 202 or the unlock control 206 are enabled, an exit cut auto lock logic can still be enabled such that if the operator raises the header assembly 114 and feeder house 116 from the lowered position, the header controller 162 may send a signal to hydraulically lock the support arms 150 and the cutterbar assembly 134 in the locked configuration until the header assembly 114 and feeder house 116 are subsequently lowered. In some implementations, the exit cut auto lock logic is enabled so long as the exit cut auto lock control 208 is enabled.

The exit cut auto lock control 208 may be selected by the operator to automatically enable exit cut auto lock logic and an exit cut auto lock system. The exit cut auto lock logic may be an algorithm or control logic stored in a memory of the controller 162. When enabled, the controller 162 is configured to control the cutterbar assembly 134 based on the position of the header assembly 114 during a harvesting operation. For example, if the header assembly 114 is in its lowered position and the agricultural machine 100 is harvesting crop near the ground (e.g., soybeans or peas), the controller 162 operably controls the cutterbar assembly 134 to the unlocked configuration to enable the cutterbar assembly 134 to move relative to changes in the terrain. If the operator actuates a control on an operator control such as a joystick 329 to raise the header assembly 114 and pause or discontinue the harvesting operation, the controller 162 operably controls the cutterbar assembly 134 to the locked configuration. With the exit cut auto lock control 208 enabled, the cutterbar assembly 134 may be controlled from the unlocked configuration to the locked configuration when the operator sends a signal to raise the header assembly 114 from its lowered position. In some implementations, a similar process is followed when the agricultural machine approaches the headland.

In a field planted with crop and to be harvested by the agricultural machine, the crop is often planted in a plurality of rows. The agricultural machine 100 may harvest one or more rows in the field during an individual pass through the field. As the agricultural machine 100 reaches the end of the one or more rows during the individual pass, the agricultural machine 100 may enter an area referred to as the headland or turnrow. The headland is an area at the end or edge or perimeter of the field where the agricultural machine 100 is able to turn around to harvest another row or group of rows in a second pass through the field. As the agricultural machine 100 approaches the end of a pass through the field, a GPS controller may communicate to a header controller that the header assembly 114 is to lock the float arm actuators 178 until the agricultural machine 100 turns around in the headland and returns to harvesting another row of crop. In some instances, the control of locking the cutterbar assembly 134 when the agricultural machine 100 approaches the headland may be automated (e.g., a signal from the GPS controller to the header controller to hydraulically lock the support arms 150 and control the cutterbar assembly 134 to the locked configuration).

In several implementations, the control of locking the cutterbar assembly 134 when the header assembly 114 is being raised during the harvesting operation regardless of the location of the agricultural machine 100 in the field may be a manual or automated process. For example, the GPS controller is one of a plurality of controllers 162 that form part of the control system 170 in FIG. 3. As described previously, the GPS controller is configured to identify a location of the agricultural machine 100 in a field being harvested. The GPS controller may send a signal to another controller (e.g., a primary or machine controller, a feeder house controller, a header controller, or other controller in the control system 170) indicating the location of the agricultural machine 100 in the field. The machine controller may receive the signal from the GPS controller and determine if the location in the field is an area the agricultural machine 100 should be harvesting. The machine controller may use a field map, for example, to determine if the location of the agricultural machine is in an area to be harvested, an area that has already been harvested, or if the agricultural machine is approaching the headland. If the machine controller determines the location of the agricultural machine 100 is in an area of the field that should not be harvested (or has already been harvested) or is approaching an area of the field that is not to be harvested and the header assembly 114 and feeder house 116 are disposed in the lowered configuration harvesting crop, the machine controller may send a signal to the feeder house controller to raise the header assembly 114 and feeder house 116 from the lowered position to the raised position. Moreover, the header controller may receive a signal from the machine controller, the feeder house controller, the GPS controller or another controller in the control system 170 to control the cutterbar assembly 134 from the unlocked configuration to the locked configuration. In doing so, the control system 170 automatically controls the cutterbar assembly 134 from the unlocked configuration to the locked configuration based on the location of the agricultural machine 100 in the field. Further, the automatic control of the cutterbar assembly 134 to the locked configuration as the header assembly 114 is raised may be executed at the headland or at any other location in the field.

In some implementations, with the exit cut auto logic enabled, the control of unlocking the cutterbar assembly 134 when the header assembly 114 is being lowered during the harvesting operation regardless of the location of the agricultural machine 100 in the field may be a manual or automated process. For example, the agricultural machine 100 may be traversing a portion of the field that is not being harvested or has already been harvested such that the header assembly 114 and feeder house 116 are in the raised position and the cutterbar assembly 134 is in the locked configuration. As described previously, the GPS controller is configured to identify a location of the agricultural machine 100 in the field. The GPS controller may send a signal to another controller (e.g., a primary or machine controller, a feeder house controller, a header controller, or other controller in the control system 170) indicating the location of the agricultural machine 100 in the field. In this example, the machine controller may receive, for example, the signal from the GPS controller and determine the location in the field is an area the agricultural machine 100 should return to harvesting crop. The machine controller may use a field map, for example, to determine that the agricultural machine is approaching or is in an area to be harvested. If the machine controller determines the location of the agricultural machine 100 is in an area of the field that should be harvested or is approaching an area of the field that is to be harvested and the header assembly 114 and feeder house 116 are disposed in the raised position, the machine controller may send a signal to the feeder house controller to lower the header assembly 114 and feeder house 116 from the raised position to the lowered position. Moreover, the header controller may receive a signal from the machine controller, the feeder house controller, the GPS controller or another controller in the control system 170 to control the cutterbar assembly 134 from the locked configuration to the unlocked configuration. In doing so, the control system 170 automatically controls the cutterbar assembly 134 from the locked configuration to the unlocked configuration based on the location of the agricultural machine 100 in the field. Further, the automatic control of the cutterbar assembly 134 to the unlocked configuration as the header assembly 114 is lowered may be executed with the exit cut auto logic enabled.

In the aforementioned example, the GPS controller sends a signal to the machine controller or control system 170 indicating the location of the machine in the field, and the machine controller takes action by automatically sending a signal to the feeder house controller to lower header assembly 114 and feeder house 116. In other implementations, an operator may send a signal to the machine controller to initiate lowering the header assembly 114 and feeder house 116 as well as unlocking the cutterbar assembly 134. Thus, when returning to cut crop during the harvesting operation, the lowering of the header assembly 114 and feeder house 116 as well as unlocking the cutterbar assembly 134 may be an automated or manual process.

In the implementation of FIG. 5, the input screen 200 includes a lock arms control 210 which, when selected, enables the operator to lock the float arm actuators 178 when the header assembly 114 is being loaded on a transport trailer, for example. In some implementations, the operator may be required to press and hold the lock arms control 210. In other implementations, the lock arms control 210 may be a toggle switch, a lever, a slider, or any other type of control that is actuated or enabled by an operator. Upon release of or disabling the lock arms control 210, the float arm actuators 178 are unlocked. The float arm actuators 178 control movement of the cutterbar assembly 134, and thus by automatically locking the float arm actuators 178 the cutterbar assembly 134 is also configured in its locked configuration. When the agricultural machine 100 exits a crop row and traverses the headland to begin harvesting another crop row, the automatic locking of the cutterbar assembly 134 can improve reel sweep and reduce crop losses.

Upon enabling or disabling of one or more controls located on the input screen 200 of the operator or user interface 160, the controller 162 directs operation of the hydraulic system 164 as shown in the method 220 of FIG. 4. For example, in block 228 of the method 220, when an operator actuates or enables the lock arms control 210, the controller 162 receives a corresponding signal that the lock arms control 210 is actuated and the controller 162 responds by controlling movement of the cutterbar assembly 134 from the flexible or unlocked configuration to the locked configuration in block 230.

In block 232, an auto lockout settings 232 is selected by the operator via the input screen 200 with a selection or enabling of the auto lock control 202. Upon selection of the auto lock control 202 in block 232, the controller 162 responds by determining the condition or state of the hydraulic system 164 and whether any other operator control is enabled via the input screen 200 such as, for example, the lock control 204, the unlock control 206, or the exit cut auto lock control 208. The auto lock control 202, lock control 204, and unlock control 206 are only used when the agricultural machine 100 is harvesting a taller crop and thus is not harvesting along the ground. Thus, the header assembly 114 and feeder house 116 may be raised to a set height when harvesting the taller crop.

If the operator selects the auto lock control 202 in block 232, the method 220 advances to block 234 where the enabling of the auto lock control 202 is associated with position or height of the gauge wheel (GW) or gauge wheels 146. As previously described, the gauge wheel 146 may be extended or retracted. When extended, the gauge wheel 146 positions the header assembly 114 at a height above the ground. When retracted, the agricultural machine 100 may harvest crop along the ground like soybeans or peas. The gauge wheel actuator 174 may be operably controlled to extend or retract the gauge wheel 146. In one implementation of method 220, a gauge wheel height sensor 179 detects a position of the gauge wheel 146 between its retracted position and extended position. Moreover, the gauge wheel height sensor 179 may also detect a change in height as the header assembly 114 moves between a raised position and a lowered position.

In some implementations, the controller 162 determines a relationship between the gauge wheel 146 and a threshold or set point. For example, in block 236 of method 220, the controller 162 determines if the position or height of the gauge wheel 146 (or gauge wheel assembly 142) is set at greater than or equal to a predefined or operator-generated set point (X % set point). In one implementation, the set point may be selectively set to a height or a percentage of extension/retraction of an actuator for controlling movement of the gauge wheel 146. This will be described in further detail below. In some implementations, the set point of X % establishes a baseline for if the agricultural machine is harvesting crop in an “on ground cutting mode” or an “off ground cutting mode.” For example, in one non-limiting implementation, the set point may be 15 %. Thus, the controller 162 may identify based on the position or height of the gauge wheel assembly as detected by the gauge wheel height sensor 179 if the agricultural machine 100 is harvesting in an “on ground cutting mode” or “off ground cutting mode.” In an “on ground cutting mode,” the controller 162 receives a signal from the gauge wheel height sensor 179 indicating the height is between 0 % and the set point (e.g., 15 % ). In an “off ground cutting mode,” the controller 162 receives a signal from the gauge wheel height sensor 179 indicating the height is greater than the setpoint (e.g., 15 %).

In the illustrated implementation of FIG. 4, the set point is shown as X %. The set point may be operator defined. In other implementations, the set point may be factory defined. In some implementations, the set point can be 15 % or less. In further implementations, the set point can be 10 % or greater. In several implementations, the set point may be predefined in the algorithm or control logic of method 220. In other implementations, the operator may be able to input the set point via an operator control. If, in block 236, the controller determines that the position or height of the gauge wheel 146 is greater than or equal to the set point (X % set point), the controller 162 is configured to controllably move the cutterbar assembly 134 to the locked configuration 230. If the controller 162 determines that the position or height of the gauge wheel 146 is less than the threshold or set point (e.g., X %) in block 238 of the method 220, the controller 162 is configured to controllably move the cutterbar assembly 134 to the unlocked configuration in block 240.

During execution of method 220, if the controller 162 receives a signal from the operator or user interface 160 that the lock control 204 is selected or actuated by the operator in block 242, the controller 162 responds accordingly by controllably moving the cutterbar assembly 134 to the locked configuration corresponding to block 230. If the unlock control 206 is selected by the operator in block 244, the controller 162 is configured to controllably move the cutterbar assembly 134 to the unlocked configuration (i.e., flexible configuration) in block 240 when the header assembly 114 is lowered.

Moreover, in one implementation, if the header assembly 114 is positioned in a transport mode, the controller 162 may controllably move the header assembly 114 to the locked configuration for transport. In some implementations, moving the header assembly 114 to the locked configuration for transport may also trigger controlling the cutterbar assembly 134 to the locked configuration in block 230. In several implementations, block 245 may be executed when an operator uses a folding application (app) on the operator or user interface 160 or a remote device (e.g., mobile device or laptop) for sending a signal to the controller 162 to move the header assembly 114 to the locked configuration.

If the exit cut auto lock control 208 is selected or enabled by the operator, the controller 162 is configured to identify when the header assembly 114 and feeder house 116 are raised as the harvesting operation is paused or discontinued. Here, the controller 162 receives a signal from the operator in which exit cut auto lock control 208 is enabled. The feeder house controller operably controls movement of the header assembly 114 and feeder house 116 between the raised and lowered positions. The header controller operably receives signals from a header height sensor 181 which detects a height of the header assembly 114 relative to the ground. The header controller operably may function in at least one of two modes – ON or OFF. When header height sensing is in the ON mode, the header assembly 114 is in the lowered position where the cutterbar assembly 134 is in the unlocked configuration where the support arms 150 are able to move based on changes in the underlying ground. When the header height sensing is in the OFF mode, the header assembly 114 is in the raised position where the cutterbar assembly 134 is in the locked configuration.

During the harvesting operation, the controller 162 is configured to detect or identify a mode or state of the header assembly 114 (i.e., header height sensing (“HHS”)). In one implementation, the mode or state of the header height sensing may be determined by the header controller based on the position of the header assembly 114 which is detected by the height sensing of the header height sensor 181. If the header controller determines the height sensing is in the OFF mode, the header assembly 114 is being raised or is in the raised position. In one implementation, the controller 162 may determine the header assembly 114 is being raised based on other inputs such as the header height which is detected by the header height sensor 181. If the controller 162 determines that the header height sensing (HHS) is in the OFF mode, then method 220 advances to block 230 such that the header controller sends a signal or command to the hydraulic system 164 to hydraulically lock the cutterbar assembly 134 in the locked configuration. When the header height sensing (HHS) is in the ON mode, the header assembly 114 is lowered to harvest crop near the ground. As such, the header controller may send a signal or command to the hydraulic system 164 to unlock the cutterbar assembly 134 to the unlocked or flexible configuration. In some implementations, the controller 162 or header controller may be programmed to return the cutterbar assembly 134 to the unlocked configuration based on a previous command or selection from the operator. By doing so, this enables the agricultural machine 100 to gather the cut crop during an exit cut while returning to and maintaining a gap between the cutterbar assembly 134 and the reel 124. By maintaining, or in some instances reducing, the gap between the cutterbar assembly 134 and the reel 124, the cutterbar assembly 134 may be kept clear of crop and debris and also a consistent harvesting operation may be maintained.

Returning to method 220, when the exit cut auto lock control 208 is selected by the operator via the input screen 200 of the operator or user interface 160, the method advances to block 246. In block 246, the controller 162 or header controller is configured to determine a state or condition of the header height sensing (HHS) and the height of the header assembly 114 relative to ground. In one implementation, the controller 162 is configured to determine the header height sensing (HHS) is in the ON mode in block 248 or the OFF mode in block 250. In some implementations, the controller 162 is a first or primary controller that receives signals from the input screen 200 or joystick 329. In other implementations, the controller 162 is the header controller that receives height sensing from the header height sensor 181 and controls the cutterbar assembly 134 between the locked and unlocked configurations. In some implementations, if the controller 162 determines that the header height sensing is in the ON mode in block 248, the controller 162 may determine the states or conditions of the various auto lock settings in block 232. If the controller 162 determines that the header height sensing (HHS) is in the OFF mode, the controller 162 may communicate with the header controller to controllably move the cutterbar assembly 134 via the hydraulic system 164 to the locked configuration in block 230.

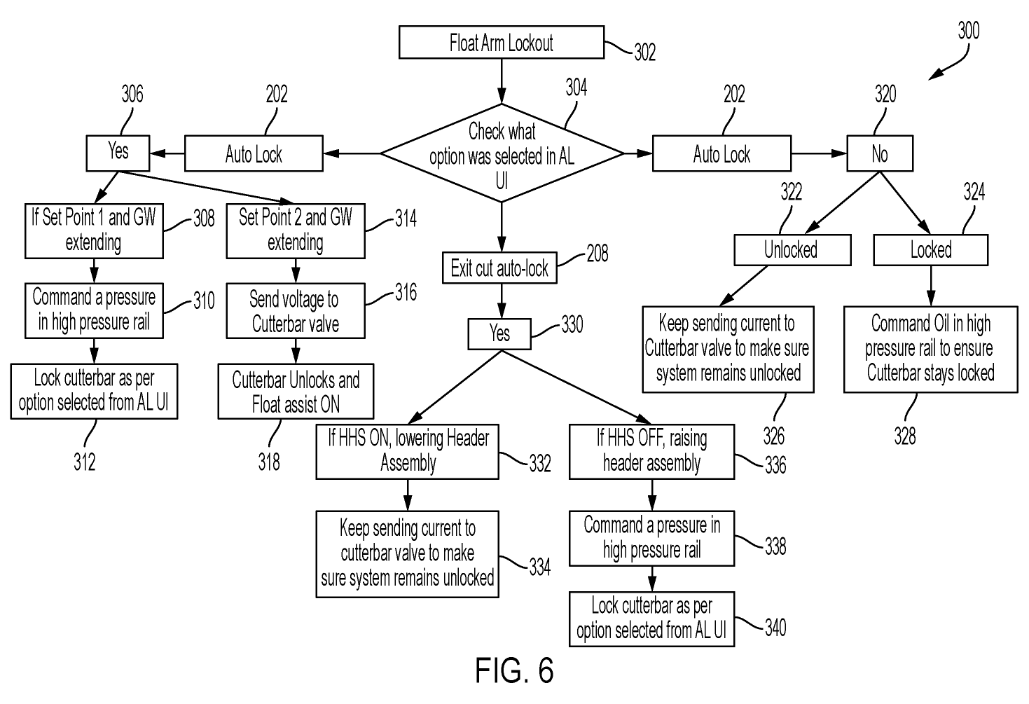

In FIG. 6, a flow diagram of a method 300 is shown for controlling the hydraulic system 164 of FIG. 3. The method 300 is shown including a plurality of blocks that may be executed by the controller 162. For example, the controller 162 may include a processor capable of executing the plurality of blocks. Moreover, the plurality of blocks of method 300 may be executed in any order. Thus, the order of the plurality of blocks in FIG. 6 is only shown as a single implementation of the method 300, and other implementations of the method 300 may include fewer blocks, more blocks, and/or the plurality of blocks arranged in an order different from that of FIG. 6. In other words, the method 300 of FIG. 6 is only one implementation of a plurality of implementations contemplated by the present disclosure and is not intended to limit the scope of the disclosure.

In one or more implementations, an operator may control the agricultural machine 100 by setting one or more setpoints. In one implementation, the operator may set at least a first setpoint (setpoint 1) and a second setpoint (setpoint 2). In other implementations, additional setpoints or fewer setpoints may be set by the operator. In yet other implementations, the setpoints may be preset or defined at the factory, by a distributor, by a third party. The first setpoint may be selected or triggered by the operator via an operator control on an operator input device or joystick 329 (see e.g., FIG. 3). In some implementations, the first setpoint may be selected by the operator when the agricultural machine 100 approaches the end of a crop row and is about to enter the headland. In another implementation, the operator may select the first setpoint at a location other than at the end of a crop row or when the agricultural machine 100 is entering or about to enter the headland.

In one implementation, the control of the hydraulic system 164 may include the control of a high pressure rail, various actuators, and a cutterbar valve 172. The high pressure rail is the main hydraulic oil supply line that fluidly connects the main drive 112 (i.e., the combine harvester) and the header assembly 114. At block 302 of the method 300, the controller 162 receives a signal from the operator interface 160. Based on the signal, the controller 162 identifies the state or position of the auto lock control 202 in block 304. If the auto lock control 202 is determined by the controller to be enabled or actuated in block 306, the controller 162 identifies in block 308 if a first set point (e.g., set point 1 in FIG. 6) is set and the gauge wheel 146 is extending or moving to an extended position. If so, method 300 advances to block 310 where a command is transmitted from the controller 162 to the hydraulic system 164 to set a pressure in the high pressure rail. Once the pressure is set in block 310, the cutterbar assembly 134 is locked in the locked configuration in block 312 based on the auto lock control 202 being selected from the auto lock by the operator via the input screen 200. If, however, the controller 162 determines in block 314 that a second set point (e.g., set point 2 in FIG. 6) is selected and the gauge wheel 146 is moving to a retracted position, a signal (e.g., current, voltage) is transmitted by the controller 162 to the cutterbar valve 172 in block 316. As the signal is sent to the cutterbar valve 172, the cutterbar assembly 134 is unlocked and the support arms 150 are able to flex relative to the changing terrain in block 318.

If it is determined that the auto lock control 202 is not selected at block 320, the method 300 advances to blocks 322, 324 where the controller 162 determines if the unlock control 206 is selected at block 322 or if the lock control 204 is selected in block 324. If the unlock control 206 is determined to be selected in block 322, a signal (e.g., current, voltage) is transmitted by the controller 162 to open the cutterbar valve 172 to tank pressure in block 326 to ensure that the cutterbar assembly 134 remains in the unlocked configuration. If the lock control 204 is determined to be selected in block 324, the hydraulic system 164 sends fluid to the high pressure rail to ensure that pressure is commanded to the cutterbar valve 172 which triggers the cutterbar assembly 134 to the locked configuration in block 328 of the method 300.

In one implementation, the operator input device 329 may include a joystick. In another implementation, the operator input device 329 may include a touchscreen with one or more selectable buttons such as on the operator interface 160. In yet other implementations, the operator input device 329 may include a lever, a switch, a mouse, or any other known type of operator control. The operator, by selecting or activating the first setpoint (e.g., setpoint 1), sends a signal to the controller 162 to move the cutterbar assembly 134 to the locked configuration, the header assembly 114 to be raised, and the feeder house 116 to be raised. By moving the cutterbar assembly 134 to the locked configuration in this implementation, the gap between the reel 124 and the cutterbar assembly 134 may be reduced to help clear the cutterbar assembly 134 of cut crop and debris. In one non-limiting example, the loss of crop while exiting the crop row during the harvesting operation may be reduced and such that the crop losses may be recovered at greater than approximately one bushel per day. The amount of crop losses that may be recovered may differ in other implementations and under varying conditions.

The second setpoint may also be selected by one or more controls on the operator input device 329. In one implementation, the second setpoint may be used by the operator to control crop harvesting positions or settings. Here, if the second setpoint is selected, the operator communicates to the controller 162 to resume harvesting when exiting the headland and entering a new crop row. By selecting the second setpoint, the header assembly 114 is moved close to the ground surface and the cutterbar assembly 134 is moved to the unlocked configuration to allow the cutterbar assembly 134 to flex or adjust along the ground surface based on changes to the contour of the ground surface. In one implementation, the second setpoint is identified as enter cut auto lock controls. In this implementation, selection of one or more of the enter cut auto lock controls transmits an enter cut signal to the controller 162 to signal to the controller 162 that the agricultural machine 100 is exiting the headland and will be entering another crop row in the field where the agricultural machine 100 is to resume harvesting.

The one or more controls on the operator input device 329 may be configured or controlled by the operator to enable the preset or define each of the one or more controls to one or more of the setpoints. In other implementations, the setpoints may be set by the operator as one or more values associated with a percentage of extension or retraction of the gauge wheel 146. As each gauge wheel 146 is controlled by a gauge wheel actuator 174, each gauge wheel actuator 174 may move from a fully retracted position (e.g., 0 %) to a fully extended position (e.g., 100 %). The operator may selectively set each setpoint to a value between 0 % and 100 % and, when a given control is selected by the operator corresponding to one of the setpoints, the gauge wheel actuator 174 moves to that designated position corresponding to the setpoint. This may be particularly useful when the operator wants to harvest crop at a certain height above the ground (e.g., 10 inches). In this disclosure, when the gauge wheels 146 engage the ground and are not fully retracted, the control system 170 is not operating in accordance with the exit cut auto lock system being active. Instead, the header assembly 114 is raised above ground and the cutterbar assembly 134 is in the locked configuration.

Referring to FIG. 6, if the controller 162 receives a signal from the operator that the exit cut auto lock control 208 is enabled in block 330 of the method 300, the controller 162 monitors the position of the header assembly 114. If the header assembly 114 is in the lowered position such that the agricultural machine 100 is harvesting crop near the ground, the header height sensing is in the ON mode and the controller 162 communicates with the header controller to ensure the cutterbar assembly 134 is in the unlocked configuration. In this case, if the operator sends a command to the controller 162 to raise the header assembly 114 and feeder house 116, the controller 162 sends a signal to the feeder house controller to raise the header assembly 114 and feeder house 116 from the lowered position to a raised position. In some instances, the signal to the feeder house controller may include a desired height or setpoint to which the header assembly 114 is moved. In any event, as the header assembly 114 is raised, the header height sensing moves to the OFF mode and the header controller sends a command to the hydraulic system 164 to command pressure to the cutterbar valve 172 to lock the cutterbar assembly 134. One or more gauge wheels may be extended to raise the header assembly 114 as described above. The operator may desire to pause or discontinue harvesting during this process of raising the header assembly 114 and thus the control system 170 moves to an exit cut disposition.

With the exit cut auto lock control 208 enabled, once the operator sends a signal to the controller 162 to lower the header assembly 114, the feeder house controller controls movement of the header assembly 114 and feeder house 116 to the lowered position. Here, the gauge wheels 146 may retract. As the header assembly 114 is lowered, the header height sensor 181 detects the height of the header assembly 114 has fallen below a threshold height such that the header height sensing mode is ON. Once the header height sensing mode is ON, the header controller receives a signal (e.g., via a CAN message or signal) to command the hydraulic system 164 to open the cutterbar valve 172 to tank pressure and unlock the cutterbar assembly 134. In the lowered position, the agricultural machine 100 may harvest crop closer to the ground such as soybeans or peas as the cutterbar assembly 134 is able to flex due to changes in terrain during the harvesting operation.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §122(f) unless an element is expressly recited using the phrase “means for,” or in the case of a method claim using the phrases “operation for” or “step for.”

While the disclosure has been illustrated and described in detail in the drawings and foregoing description, such illustration and description are to be considered as exemplary and not restrictive in character, it being understood that illustrative implementation(s) have been shown and described and that all changes and modifications that come within the spirit of the disclosure are desired to be protected. It will be noted that alternative implementations of the present disclosure may not include all of the features described yet still benefit from at least some of the advantages of such features. Those of ordinary skill in the art may readily devise their own implementations that incorporate one or more of the features of the present disclosure and fall within the spirit and scope of the present disclosure as defined by the appended claims.

1. A header system of an agricultural machine for performing a harvesting operation to harvest a crop in a field, comprising:
a header assembly comprising a frame, a cutterbar assembly configured to cut the crop during the harvesting operation, and a plurality of support arms coupled between the frame and the cutterbar assembly, wherein the cutterbar assembly is controlled between an unlocked configuration and a locked configuration; and
a control system configured to control the header assembly between a raised position and a lowered position and the cutterbar assembly between the unlocked configuration and the locked configuration;
wherein, when the header assembly is in the lowered position and the cutterbar assembly is in the unlocked configuration, in response to a signal the control system is configured to move the header assembly from the lowered position to the raised position and control the cutterbar assembly from the unlocked configuration to the locked configuration.

2. The header system of claim 1, wherein the control system includes an operator control, the control system configured to receive the signal from the operator control to move the header assembly from the lowered position to the raised position and control the cutterbar assembly from the unlocked configuration to the locked configuration.

3. The header system of claim 1, wherein the control system includes a controller configured to detect a location of the agricultural machine in the field, the control system configured to receive the signal from the controller to automatically move the header assembly from the lowered position to the raised position and control the cutterbar assembly from the unlocked configuration to the locked configuration based on the location of the agricultural machine in the field.

4. The header system of claim 3, wherein, when the signal is from the controller and identifies that the location of the agricultural machine is in or approaching a headland portion of the field, the control system is configured to automatically send a second signal to move the header assembly from the lowered position to the raised position and a third signal to control the cutterbar assembly from the unlocked configuration to the locked configuration.

5. The header system of claim 3, wherein the control system includes a second controller configured to control the agricultural machine, the second controller configured to:
receive the signal from the controller;
determine, based on the signal and a field map, if the location of the agricultural machine corresponds to a first area or a second area in the field;
if the location is in the first area, maintain the header assembly in the lowered position and the cutterbar assembly in the unlocked configuration; and
if the location is in the second area, automatically move the header assembly from the lowered position to the raised position and control the cutterbar assembly from the unlocked configuration to the locked configuration.

6. The header system of claim 1, wherein the control system includes at least one sensor coupled to the header assembly, the at least one sensor configured to detect a height of the header assembly relative to a ground surface in the field.

7. The header system of claim 1, wherein the header assembly is controllable in a first mode and a second mode;
wherein, in the first mode, the header assembly is disposed in the lowered position and the cutterbar assembly is in the unlocked position;
wherein, in the second mode, the header assembly is disposed in the raised position and the cutterbar assembly is in the locked position.

8. The header system of claim 1, wherein the control system includes an operator control configured to be selectively enabled to hold the cutterbar assembly in the locked configuration;
wherein, when the operator control is selectively enabled, the control system is configured to maintain the cutterbar assembly in the locked configuration independent of the signal.

9. The header system of claim 1, further comprising a hydraulic system disposed in communication with the control system, wherein the control system is configured to enable the hydraulic system for moving the header assembly between the lowered position and the raised position and moving the cutterbar assembly between the locked configuration and the unlocked configuration.

10. A header system of an agricultural machine performing a harvesting operation to harvest crop in a field, comprising:
a header assembly comprising a frame, a cutterbar assembly configured to cut the crop during the harvesting operation, and a plurality of support arms coupled between the frame and the cutterbar assembly, wherein the cutterbar assembly is controlled between an unlocked configuration and a locked configuration;
an operator interface comprising a plurality of operator controls, the plurality of operator controls including a first operator control and a second operator control, wherein, when the first operator control is enabled, the first operator control is configured to automatically control the cutterbar assembly to the locked configuration, and when the second operator control is enabled, the second operator control is configured to enable an exit cut auto lock logic; and
a control system comprising at least one controller, the control system configured to control the header assembly between a raised position and a lowered position and the cutterbar assembly between the unlocked configuration and the locked configuration;
wherein, when the header assembly is in the lowered position and the cutterbar assembly is harvesting crop during the harvesting operation, in response to a signal from one of the plurality of operator controls or the at least one controller, the control system is configured to move the header assembly from the lowered position to the raised position and control the cutterbar assembly from the unlocked configuration to the locked configuration.

11. The header system of claim 10, wherein the control system includes at least one sensor, the at least one sensor configured to detect a height of the header assembly relative to a ground surface in the field.

12. The header system of claim 10, wherein, when the first operator control is enabled, the cutterbar assembly is in the locked configuration independent of whether the header assembly is in the raised position or lowered position.

13. The header system of claim 12, wherein only the first operator control or the second operator control is configured to be selectively enabled.

14. The header system of claim 10, wherein, when the second operator control is enabled and the cutterbar assembly is in the unlocked configuration, the control system is configured to receive the signal from the at least one controller to automatically move the header assembly from the lowered position to the raised position and control the cutterbar assembly from the unlocked configuration to the locked configuration.

15. The header system of claim 10, wherein, when the second operator control is enabled and the cutterbar assembly is in the unlocked configuration, the control system is configured to receive the signal from a third operator control of the plurality of operator controls to move the header assembly from the lowered position to the raised position and control the cutterbar assembly from the unlocked configuration to the locked configuration.

16. The header system of claim 10, wherein the at least one controller includes a first controller configured to control the agricultural machine, a second controller configured to move the header assembly between a raised position and a lowered position, a third controller configured to control the cutterbar assembly between the unlocked configuration and locked configuration, and a fourth controller configured to identify a location of the agricultural machine in the field.

17. The header system of claim 16, wherein the control system is configured to receive the signal from the fourth controller and automatically move the header assembly from the lowered position to the raised position and control the cutterbar assembly from the unlocked configuration to the locked configuration based on the location of the agricultural machine in the field.

18. The header system of claim 16, wherein, when the signal is from the fourth controller and identifies that the location of the agricultural machine is in or approaching a headland portion of the field, the control system is configured to automatically send a second signal to the second controller to move the header assembly from the lowered position to the raised position and a third signal to the third controller to control the cutterbar assembly from the unlocked configuration to the locked configuration based on the location of the agricultural machine in the field.

19. A method of controlling a header system of an agricultural machine during a harvesting operation in a field, the method comprising:
providing a header assembly including a cutterbar assembly and a plurality of support arms operably coupled to the cutterbar assembly, a hydraulic system, and a control system comprising an operator control, a controller, and a sensor;
harvesting, via the header assembly, a crop in the field during the harvesting operation with the header assembly disposed in a lowered position and the cutterbar assembly disposed in an unlocked configuration;
receiving, via the control system, a first signal from the operator control to enable an exit cut auto lock algorithm;
during the harvesting operation, receiving a second signal via the control system from the operator control or controller to move the header assembly from the lowered position to a raised position;
operably moving, via the control system, the header assembly from the lowered position to the raised position; and
controllably moving, via the control system, the cutterbar assembly from the unlocked configuration to the locked configuration.

20. The method of claim 19, wherein, when the exit cut auto lock algorithm is enabled, the header assembly is in the raised position, and the cutterbar assembly is in the locked configuration, the method further includes:
receiving a third signal, via the controller, from the operator control or the controller to lower the header assembly from the raised position to the lowered position;
operably moving the header assembly from the raised position to the lowered position;
detecting, via the sensor, the header assembly is in the lowered position; and
controllably moving, via the control system, the cutterbar assembly from the locked configuration to the unlocked configuration.
